(19) United States
(12) Patent Application Publication
(10) Pub. No.: US 2026/0059050 A1
(43) Pub. Date: Feb. 26, 2026

(54) METHODS AND SYSTEMS FOR HANDLING INCOMING CLIENT CALLS

(71) Applicant: Royal Bank of Canada, Toronto (CA)

(72) Inventors: Yi Lian, Richmond Hill (CA); Sara Naeem, Toronto (CA); Albina Babuk, Vaughan (CA); Noah Ripstein, Toronto (CA); Cheryl McConachie, Toronto (CA); Abhishek Bachal, Toronto (CA); Isabel White, Toronto (CA)

(21) Appl. No.: 19/302,477

(22) Filed: Aug. 18, 2025

Related U.S. Application Data
(60) Provisional application No. 63/685,513, filed on Aug. 21, 2024.

(51) Int. Cl. H04M 3/51; G10L 15/14; G10L 15/16; G10L 15/30; H04M 3/42; H04M 3/523

(52) U.S. Cl. CPC H04M 3/5166; G10L 15/14; G10L 15/16; G10L 15/30; H04M 3/42221; H04M 3/5183; H04M 3/5235; H04M 2201/40; H04M 2201/41

(57) ABSTRACT

A method of handling an incoming call from a client includes receiving call data, the voice data including at least voice data generated based on the client's voice during the call. The call data is processed to identify, using at least one trained machine learning model, at least one first action that can be completed during the call by the client without assistance from a human advisor. The client is invited to complete the at least one first action.

### FIELD

The present disclosure relates to data processing and in particular to methods and systems for handling incoming client calls.

### BACKGROUND

Large corporate entities, such as financial institutions, may receive millions of client interactions annually, spanning across a correspondingly vast number of unique clients. These interactions occur via multiple channels, including telephony and online messaging platforms, and may involve both live human advisors and automated agents. However, as the volume and complexity of client inquiries grow, human advisor workloads increase accordingly. This leads to longer client wait times and/or extended interaction durations, particularly when the number of active advisors remains static.

### SUMMARY

According to a first aspect of the disclosure, there is provided a method, performed by one or more computer processors, of handling an incoming call from a client, comprising: receiving call data comprising at least voice data generated based on the client's voice during the call; processing the call data to identify, using at least one trained machine learning model, at least one first action that can be completed during the call by the client without assistance from a human advisor; and inviting the client to complete the at least one first action.

Receiving the call data may comprise: during the call, delivering one or more instructions to the client; receiving, from the client, one or more responses to the one or more instructions; and generating the voice data based on the one or more responses.

Receiving the call data may further comprise recording the one or more responses. Generating the voice data may comprise generating the voice data based on the recorded one or more responses.

Receiving the call data may comprise retrieving, from among client data relating to multiple clients, client data specific to the client.

Retrieving the client data may comprise: identifying one or more identifiers of the client; and based on the one or more identifiers, retrieving the client data.

The call data may further comprise client data specific to the client. Processing the call data may comprise: inputting the voice data and the client data to the at least one trained machine learning model; and identifying, based on an output of the at least one trained machine learning model, the at least one first action.

The at least one trained machine learning model may comprise a trained multinomial Naïve Bayes classifier or a trained random forest classifier.

Processing the call data may further comprise: inputting the voice data to a first trained machine learning model of the at least one trained machine learning model; inputting the client data to a second trained machine learning model of the at least one trained machine learning model; and identifying, based on respective outputs of the first and second trained machine learning models, the at least one first action.

The first and second trained machine learning models may be neural networks.

Processing the call data may further comprise identifying at least one second action requiring assistance from the human advisor to be completed.

The method may further comprise placing the client in a virtual queue for the human advisor.

Inviting the client to complete the at least one first action may comprise inviting the client to complete the at least one first action while the client is in the virtual queue.

The method may further comprise: receiving a notification that the client has completed the at least one first action; and in response to receiving the notification and in response to determining that no further actions need to be completed, ending the call.

The method may further comprise, in response to the client reaching the front of the virtual queue, connecting the client to the human advisor whether or not the at least one first action has been completed by the client.

Inviting the client to complete the at least one first action may comprise sending, to a device of the client, a hyperlink for the client to access and thereby complete the at least one first action.

The method may further comprise: receiving a notification that the client has completed the at least one first action; and notifying the human advisor that the client has completed the at least one first action.

The method may further comprise notifying the human advisor of the at least one first action that needs to be performed.

According to a further aspect of the disclosure, there is provided a system comprising one or more processors and a computer-readable medium storing computer program code configured, when executed by the one or more processors, to cause the one or more processors to perform any of methods as described herein.

This summary does not necessarily describe the entire scope of all aspects. Other aspects, features, and advantages will be apparent to those of ordinary skill in the art upon review of the following description of specific embodiments.

### DRAWINGS

Embodiments of the disclosure will now be described in detail in conjunction with the accompanying drawings of which:

FIG. 1 depicts a computer network that comprises a system for handling incoming client calls, according to an embodiment of the disclosure;

FIG. 2 is a block diagram of a server comprised in the system depicted in FIG. 1, according to an embodiment of the disclosure;

FIG. 3 is a flow diagram of a method of handling incoming client calls, according to an embodiment of the disclosure; and

FIG. 4 is a schematic diagram of a system for handling incoming client calls, according to an embodiment of the disclosure.

### DETAILED DESCRIPTION

The present disclosure seeks to provide novel methods and systems for handling incoming client calls. While various embodiments of the disclosure are described below, the disclosure is not limited to these embodiments, and variations of these embodiments may well fall within the scope of the disclosure which is to be limited only by the appended claims.

In order to reduce call handling times and improve efficiency in client service environments, there are described herein methods and systems that allow for organizations to more efficiently handle their clients'incoming calls. In particular, advisor handle time (AHT: the total time taken by a human agent/advisor to deal with a client call) may be reduced by providing the client with the opportunity to deal with specific issues while the client is waiting to speak to the advisor. As such, when the client is eventually connected to the advisor, the advisor may be required to assist the client with fewer outstanding issues or actions. In some cases, it may be possible for the client to resolve all of their issues independently during the waiting period, thereby eliminating the need for any interaction with a human advisor and allowing the call to be concluded without escalation.

Generally, when a client contacts a large organization (such as their bank) to resolve certain issues (for example, to replace a lost or stolen credit card, or to transfer funds from one account to another), the caller is first prompted by an automated system to describe the reason for their call. In accordance with certain embodiments of the disclosure, a trained machine learning model may be used to transcribe and summarize the client's explanation of the issue(s) in response to the automated system's initial prompt. The trained model may then use the summary, and optionally associated client data (e.g., information such as the client's age, demographic, and/or a list of any products currently held by the client in connection with the bank), to predict the most likely action(s) that a human advisor will need to take in order to resolve the client's issue(s).

If the required actions include one or more “self-serve” actions (that is, actions that the client can perform themselves without the need for assistance from an advisor), then the client may be notified (for example, using a push notification that is sent to the client's mobile device) that, while they wait in a queue to speak to an advisor, they may complete these “self-serve” actions before speaking to the agent. The client may be also provided with means to complete these self-serve actions. For example, according to some embodiments, a hyperlink may be sent to the client's mobile device to allow the client to access a web page whereon the client may perform the self-serve action(s).

For any non-“self-serve” actions (that is, actions that will require the assistance of an advisor to complete), a summary of any such actions may be provided to the advisor before, or at the same time that, the advisor is placed in communication with the client. In addition to this summary, training information may be provided to the advisor for dealing with the action(s). This summary and any associated training information may assist the advisor in identifying the steps that will need to be taken to complete the actions.

For example, according to some embodiments, before being connected with a caller, the advisor may be presented (for example, on a user interface) with a complete list of actions that need to be completed in order to deal with the issue(s) the client is facing. Each action that is presented to the advisor may be either an action that can be handled by the client on their own (i.e., is a self-serve action) or may be an action that will require assistance from the advisor. Each action will have been identified based on a prediction output by the machine learning model, the prediction being based on the transcript generated at the start of the call and optionally also being based on specific client data associated with the client. Each action may be associated with a status, and therefore, if the client has completed one or more of the actions while waiting to be connected to the advisor, then the advisor will be aware of this when placed in contact with the client. For example, if the client is calling because they have lost their credit card, the advisor may be presented with three actions: 1) report the card as lost/stolen (this may be an action that only the advisor can perform); 2) lock the lost card (this may be an action that the client can perform on their own and, if already performed by the client, will be indicated as such to the agent); and 3) the client must verify their mailing address for the replacement card (this may be an action that the client can perform on their own and, if already performed by the client, will be indicated as such to the agent).

Therefore, in accordance with embodiments of the disclosure, there is described a method (and associated system), performed by one or more computer processors, of handling an incoming call from a client. The method includes receiving call data comprising at least voice data generated based on the client's voice during the call. The method further includes processing the call data to identify, using at least one trained machine learning model, at least one first action (i.e., at least one “self-serve” action) that can be completed during the call by the client without assistance from a human advisor. The method includes inviting the client to complete the at least one first action. Processing the call data may further comprise identifying at least one second action requiring assistance from the human advisor to be completed. The method may further comprise placing the client in a virtual queue for the human advisor.

The client may be invited to complete at least one self-serve action while waiting in the virtual queue. The client may continue to move forward in the queue regardless of whether they choose to complete the self-serve action(s), and their position may not be deprioritized based on their engagement with such actions. In some embodiments, the client may alternatively be invited to complete one or more self-serve actions prior to being placed in the virtual queue. In either case, the opportunity to perform self-serve actions may not delay the client's access to an advisor, and any incomplete actions may be resolved with the advisor once the client reaches the front of the queue.

As can be seen, the methods and systems described herein may transfer some of the burden of dealing with client requests from advisors to the client themselves, in cases where the client is likely able to complete the action(s) themselves. As such, the client helps reduce the number of actions the advisor will need to assist with, as well as the amount of time the advisor will take to assist the client, by providing the client with the opportunity to complete any self-serve actions while they wait in the queue. This also improves the client's experience, as they are empowered to complete actions on their own to help them resolve their own issue(s), while making the advisor's task of assisting the client more efficient once they are connected. This may reduce the advisor handling time and therefore reduce the overall call time of clients.

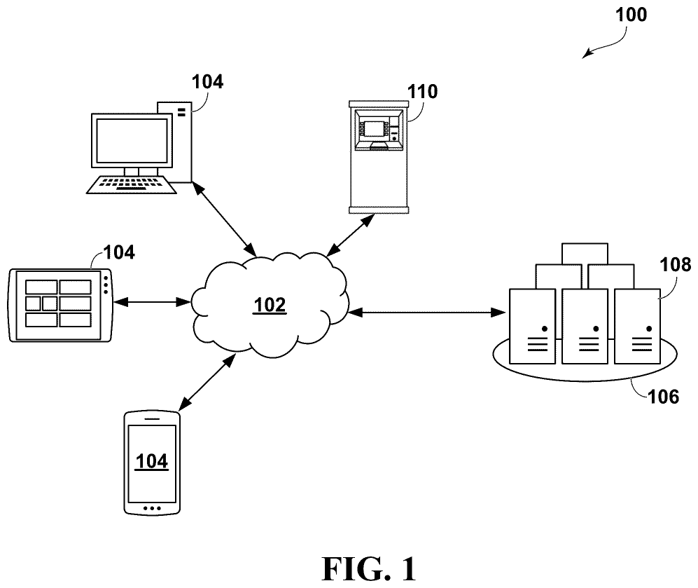

Referring now to FIG. 1, there is shown a computer network 100 that comprises an example embodiment of a system 100 for handling incoming client calls. More particularly, computer network 100 comprises a wide area network 102 such as the Internet to which various user devices 104, an ATM 110, and a data center 106 are communicatively coupled. Data center 106 comprises a number of servers 108 networked together to collectively perform various computing functions. For example, in the context of a financial institution such as a bank, data center 106 may host online banking services that permit users to log in to servers 108 using user accounts that give them access to various computer-implemented banking services, such as online fund transfers. Furthermore, individuals may appear in person at ATM 110 to withdraw money from bank accounts controlled by data center 106.

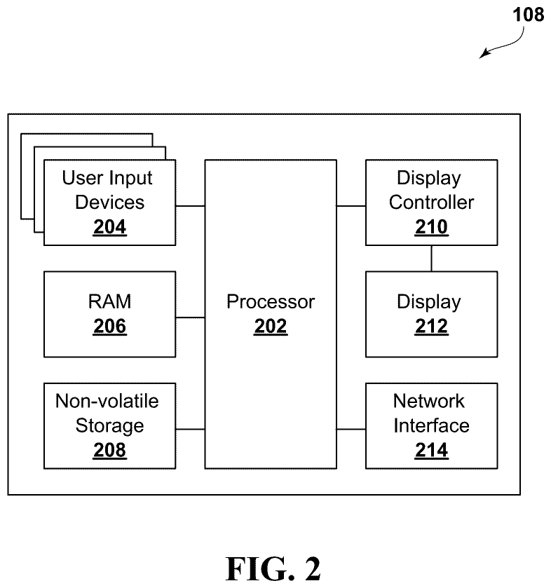

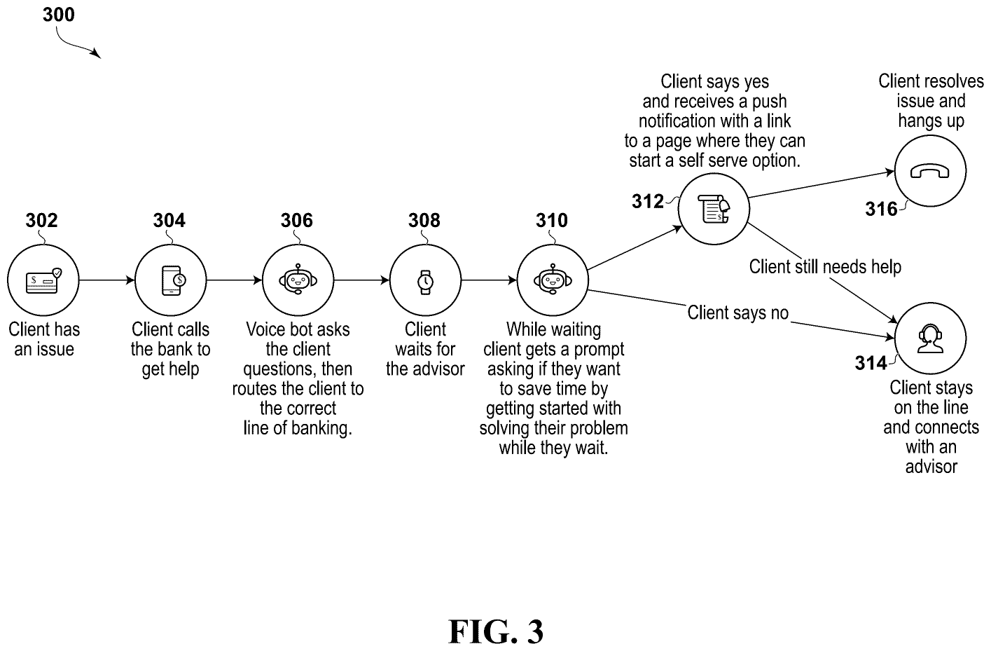

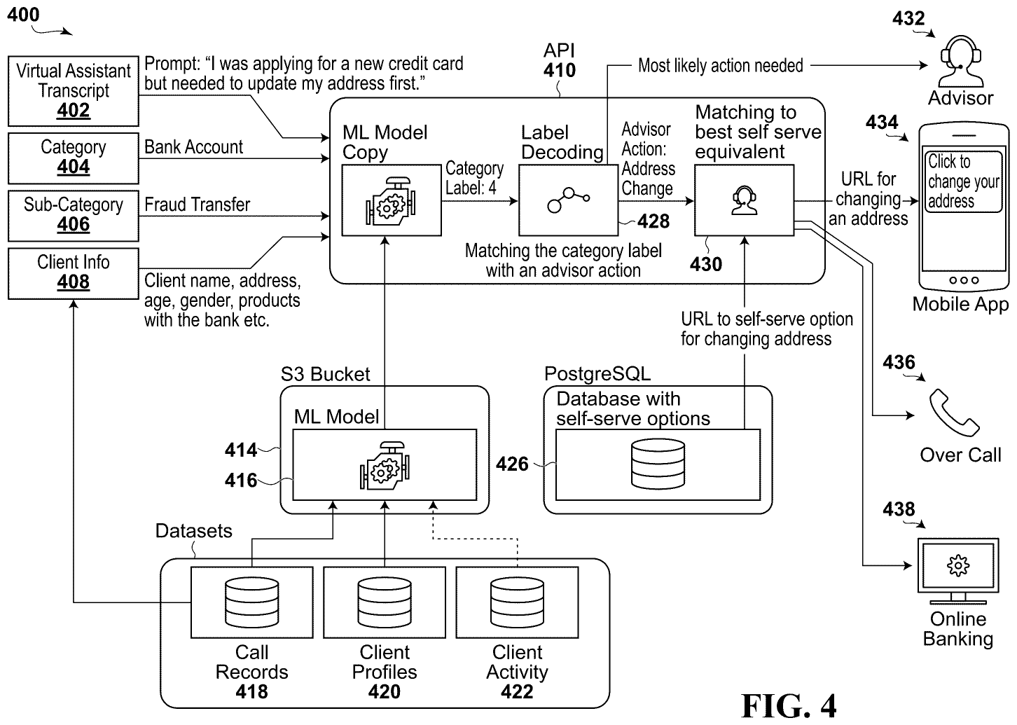

Referring now to FIG. 2, there is depicted an example embodiment of one of the servers 108 that is comprised in data center 106. The server 108 comprises a processor 202 that controls the server 108's overall operation. Processor 202 is communicatively coupled to and controls several subsystems. These subsystems comprise user input devices 204, which may comprise, for example, any one or more of a keyboard, mouse, touch screen, voice control; random access memory (“RAM”) 206, which stores computer program code for execution at runtime by the processor 202; non-volatile storage 208, which stores the computer program code executed by the RAM 206 at runtime; a display controller 210, which is communicatively coupled to and controls a display 212; and a network interface 214, which facilitates network communications with wide area network 104 and the other servers 108 in the data center 106. Non-volatile storage 208 has stored on it computer program code that is loaded into RAM 206 at runtime and that is executable by processor 202. When the computer program code is executed by processor 202, processor 202 causes the server 108 to implement a method for handling incoming client calls, such as is described in more detail in connection with FIGS. 3 and 4 below. Additionally or alternatively, servers 108 may collectively perform the method for handling incoming client calls using distributed computing. While the system depicted in FIG. 2 is described specifically in respect of connection with one of the servers 108, analogous versions of the system may also be used for user devices 104.

Referring now to FIG. 3, there is shown a flow diagram of a method of handling incoming client calls, according to an embodiment of the disclosure.

At block 302, a client determines that they have an issue that needs resolving. For example, the client may have lost their credit card and needs to order a replacement credit card.

At block 304, the client contacts their bank, for example by telephone, to order the replacement credit card.

At block 306, an automated system receives the call and generates one or more prompts formulated as questions in order to understand the issue the client is facing. The automated system may comprise a computer program designed to play one or more audio recordings to the client. For example, the automated system may play the recording: “In a few words, please describe what it is you need help with.” According to some embodiments, instead of the automated system playing a number of recordings, the automated system may comprise a machine learning model trained to interact with the caller and to dynamically generate and deliver contextually relevant prompts (for example, based on general conversational patterns or client profile data associated with the caller).

In response to the client's answers, the automated system, using a trained machine learning model (which may be referred to throughout as a “prediction engine”), processes the client's answers as described in further detail below, and identifies one or more actions that need to be taken in order for the client's issue to be resolved. In addition to identifying the actions that need to be completed to deal with the client's issue, the automated system is able to identify a category that the issue relates to, as well as one or more subcategories. For example, in the case of a lost credit card, the category may be “credit cards”, and the subcategory may be “ordering a replacement card”.

The processing may also include the prediction engine accessing client data that is specific to the client, and processing the client data in combination with the client's description of their issue. Such client data (which may include, for example, personal details of the client such as their age and demographic) may be accessed based on authentication information that has been provided by the client at the beginning of the call. For example, based on the client's phone number which may be known to the automated system as a result of the call being placed by the client, and based on confirmation from the client of personal details such as their address and/or their full name, the automated system may retrieve the relevant client data that is stored on a database of the bank. The automated system then informs the client that they are being placed in a queue to speak to an appropriate agent who will be able to resolve their issue.

At block 308, the client is placed in a virtual queue to speak to an appropriate advisor. The particular queue that the client is placed in may be based on the identified category and/or subcategory the automated system has identified the issue relates to.

While the client is waiting in the queue, the prediction engine determines whether any of the identified actions are capable of being completed by the client themselves (i.e., whether any of the identified actions are so-called “self-serve” actions). If the prediction engine identifies any self-serve actions, then, at block 310, the automated system notifies the client that one or more of the actions that need to be completed may be resolved by the client, and asks the client whether they would be interested in completing these actions themselves. The automated system may additionally inform the client that their place in the queue will not be lost if they choose to complete these actions themselves.

At block 312, if the client indicates that they would like to complete the self-serve actions, the automated system may send a push notification to the caller's mobile device or desktop computer that allows the caller to complete the self-serve action(s) themselves. For instance, the push notification may include a hyperlink to a web page that allows the caller to complete the self-serve action(s) themselves. Examples of self-serve actions include locking a lost credit card, updating a mailing address, and providing relevant preliminary information to the advisor.

After initiating one or more self-serve actions, the client continues to advance in the same virtual queue for an advisor as they would have had they not elected to perform the self-serve actions. The client's position is not penalized or delayed as a result of engaging with the self-serve options. If the client reaches the front of the queue before completing the self-serve actions, they may be nonetheless connected with an advisor as per their original queue position. Any outstanding actions at that point may then be addressed by the advisor. If, after completing the self-serve actions, the client's issue has been resolved, then at block 316 the call may be ended.

Alternatively, if, after completing the self-serve actions, the client's issue has not been resolved (for example, if there are non-self-serve actions that require the assistance of an advisor, or if the client is unable to complete one or more of the self-serve actions), then at block 314 the client is kept in the queue until an advisor is made available.

If the client indicates that they are not interested in completing the self-serve action(s), then, at block 314, the client is kept in the queue until an advisor is made available.

As described above, the automated system may generate a summary of the actions likely required to resolve the client's issue, as predicted by the prediction engine. This summary can be provided to the advisor either before or at the time the advisor is connected with the client. In addition to the summary, training information may also be provided to assist the advisor in addressing the predicted actions, as well as indicators showing which, if any, self-serve actions have already been completed by the client. Once the advisor has finished resolving the client's issue, then, at block 316, the call is ended.

According to some embodiments, if the prediction engine determines that a human advisor is not needed in order to resolve the issue, then the automated system may inform the caller that all of the required actions may be completed by the client without the need for an advisor, and may invite the client to complete all actions themselves as described above. If the client declines, then the automated system may place the client in a queue for an advisor, as also described above.

Turning to FIG. 4, there is shown an example system 400 for handling incoming client calls, according to an embodiment of the disclosure.

When a client contacts their bank to resolve an issue, call data is generated by system 400. The call data includes at least voice data generated based on the client's voice during the call. For example, as described above, the client may be prompted by the automated system to describe the issue they are facing. The voice recording of the caller may then be processed, for example using a trained machine learning model, such as a trained language model, to generate a transcript 402 of the call. The call data may additionally include a category 404 and sub-category 406 identifying the type of issue the client is seeking to resolve. The call data may further include client data 408 which may be information specific to the client, such as their age, demographic, address, profitability, gender, and/or a list of any products that the client currently has with the bank. Transcript 402, category 404, and sub-category 406 are stored in a call records database 418 of the bank, while client data 408 is stored in a client profiles database 420 of the bank.

System 400 includes an S3 bucket 414 or similar container in which is stored the prediction engine 416 described above. Prediction engine 416 is trained based on training data comprising call records 418 (including transcripts, categories of calls, and subcategories of calls), and client profiles data 420 associated with the clients having initiated these calls. The training data additionally includes data indicative of what action(s) were completed for each call. This training data may be used to train, using supervised machine learning techniques, a classification algorithm, such as Multinomial Naïve Bayes classifier or a random forest classifier. In particular, each call transcript may be vectorized (using, for example, Term Frequency-Inverse Document Frequency (TF-IDF) or Word2Vec), and the vectorized text is then appended with tabular data indicative of the call's category, subcategory, client profile information associated with the client, and data indicative of the actions that were completed to resolve the client's issue.

According to some embodiments, the call data described above may be used to train a deep learning model comprising a pair of concatenated neural networks. In particular, a first neural network may be configured to receive input derived from the call transcripts stored in call records 418, while a second neural network may be configured to receive the tabular data, including each call's category, subcategory, client profile information associated with the caller, and data indicative of the actions taken to resolve the client's issue. The outputs of the first and second neural networks may then be concatenated to form a joint representation, such that the two networks collectively operate as a single deep learning model.

According to some embodiments, prediction engine 416 may additionally be trained using client activity data stored in a client activity database 422 of the bank. This data may be indicative, for example, of pages visited by the client using their client's mobile application, and may therefore assist prediction engine 416, when deployed, in better predicting the likely actions that need to be performed in order to resolve a client's issue. For example, if a client has recently viewed multiple help articles related to credit card limits, this behavioral pattern may be used to augment the model's confidence that the client is calling to request a limit increase.

Based on this training data, prediction engine 416 learns the relationships between different customer queries and the associated most likely action(s) that need to be taken for the issue to be resolved. As a result, when call data is input into trained prediction engine 416, prediction engine 416 may output one or more numerical or other labels, with each label being associated with a corresponding action. Prediction engine 416 may additionally output a confidence rating indicative of how confident prediction engine 416 is with its output—such a rating may be used for the purpose of evaluating the model's performance over time.

System 400 further includes an API 410 integrated into the automated system and configured to respond to and process a client's call. In particular, upon receiving a call from a client, API 410 accesses trained prediction engine 416 stored in S3 bucket 414. Based on the transcript 402 of the call as well as associated client data retrieved from client profiles database 420, prediction engine 416 generates a label corresponding to one or more likely actions that need to be performed to resolve the client's issue. At block 428, prediction engine 416 converts the label into corresponding actions. In particular, the actions to be performed are identified by cross-referencing the label in a look-up table.

API 410 then identifies, based on the actions output from the label decoding, which actions are self-serve actions. This may be determined with access to a database 426 storing a complete list of self-serve actions. API 410 then retrieves from database 426 the URLs that may be used by the client to complete the self-serve actions. The retrieved URLs are transmitted to the client's device, and for example may be displayed to the client via the client's mobile application 434. As described above, by accessing the appropriate URL, the client may then complete the self-serve action(s) either via the mobile application 434 or the bank's online banking platform 438. According to some embodiments, it may be possible for the client to resolve self-serve actions using only their voice 436 (as opposed to requiring the caller to interact with their desktop computer or mobile application). In such cases, voice interaction may trigger a natural language processing system that guides the user through the completion steps.

Meanwhile, API 410 generates a summary of the actions to be completed and forwards the summary to the agent 432 that will assist the client with any remaining non-self-serve actions. The summary may also include real-time status indicators reflecting which self-serve actions have already been completed by the client.

### Example 1

The prediction engine may identify, according to the transcript generated based on the client's audio interaction with the system, that the client is calling about a lost or stolen card. The prediction engine may therefore identify that the client is very likely to request a new card during a call with an advisor—this requires an address verification/update. While the client is waiting in a queue for an advisor, the automated system may ask the client to verify the address that is currently on file for them. For example, the automated system may request that the client say their current address, or a portion of their current address. If, based on their response, the automated system determines that their address requires updating, the automated system may notify the client that, by logging into their online banking platform or their mobile app, the client may access a link to the web page through which they may update their address. As a result, the completion of this action is offloaded from the advisor to the client while the client is waiting in the queue.

### Example 2

The prediction engine may identify, according to the transcript generated based on the client's audio interaction with the system, that the client is calling about transferring funds from their registered investment account. In order to do this, the client may need to update the bank's records of their investment goals (such as risk tolerance, investment horizon, and similar criteria). This record is called a “know your client” (KYC) record. Such KYC updates generally need to occur at least once per year in order for the client to access their registered investment account. The prediction engine may therefore determine whether the client's KYC is unchanged, or may prompt them to update their KYC on a web page, while the client is waiting in a queue to speak with an advisor.

Any of the processors used in the foregoing embodiments may comprise, for example, a processing unit (such as a processor, microprocessor, or programmable logic controller) or a microcontroller (which comprises both a processing unit and a non-transitory computer readable medium). Examples of computer-readable media that are non-transitory include disc-based media such as CD-ROMs and DVDs, magnetic media such as hard drives and other forms of magnetic disk storage, semiconductor based media such as flash media, random access memory (including DRAM and SRAM), and read only memory. As an alternative to an implementation that relies on processor-executed computer program code, a hardware-based implementation may be used. For example, an application-specific integrated circuit (ASIC), field programmable gate array (FPGA), system-on-a-chip (SoC), or other suitable type of hardware implementation may be used as an alternative to or to supplement an implementation that relies primarily on a processor executing computer program code stored on a computer medium.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise. It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups.

It is contemplated that any part of any aspect or embodiment discussed in this specification can be implemented or combined with any part of any other aspect or embodiment discussed in this specification.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

1. A method, performed by one or more computer processors, of handling an incoming call from a client, comprising:
receiving call data comprising at least voice data generated based on the client's voice during the call;
processing the call data to identify, using at least one trained machine learning model, at least one first action that can be completed during the call by the client without assistance from a human advisor; and
inviting the client to complete the at least one first action.

2. The method of claim 1, wherein receiving the call data comprises:
during the call, delivering one or more instructions to the client;
receiving, from the client, one or more responses to the one or more instructions; and
generating the voice data based on the one or more responses.

3. The method of claim 2, wherein:
receiving the call data further comprises recording the one or more responses; and
generating the voice data comprises generating the voice data based on the recorded one or more responses.

4. The method of claim 1, wherein receiving the call data comprises:
retrieving, from among client data relating to multiple clients, client data specific to the client.

5. The method of claim 4, wherein retrieving the client data comprises:
identifying one or more identifiers of the client; and
based on the one or more identifiers, retrieving the client data.

6. The method of claim 1, wherein:
the call data further comprises client data specific to the client; and
processing the call data comprises:
inputting the voice data and the client data to the at least one trained machine learning model; and
identifying, based on an output of the at least one trained machine learning model, the at least one first action.

7. The method of claim 6, wherein the at least one trained machine learning model comprises a trained multinomial Naïve Bayes classifier.

8. The method of claim 6, wherein the at least one trained machine learning model comprises a trained random forest classifier.

9. The method of claim 6, wherein processing the call data further comprises:
inputting the voice data to a first trained machine learning model of the at least one trained machine learning model;
inputting the client data to a second trained machine learning model of the at least one trained machine learning model; and
identifying, based on respective outputs of the first and second trained machine learning models, the at least one first action.

10. The method of claim 9, wherein the first and second trained machine learning models are neural networks.

11. The method of claim 1, wherein:
processing the call data further comprises identifying at least one second action requiring assistance from the human advisor to be completed.

12. The method of claim 1, further comprising placing the client in a virtual queue for the human advisor.

13. The method of claim 12, wherein inviting the client to complete the at least one first action comprises inviting the client to complete the at least one first action while the client is in the virtual queue.

14. The method of claim 12, further comprising:
receiving a notification that the client has completed the at least one first action; and
in response to receiving the notification and in response to determining that no further actions need to be completed, ending the call.

15. The method of claim 12, further comprising:
in response to the client reaching the front of the virtual queue, connecting the client to the human advisor whether or not the at least one first action has been completed by the client.

16. The method of claim 1, wherein inviting the client to complete the at least one first action comprises sending, to a device of the client, a hyperlink for the client to access and thereby complete the at least one first action.

17. The method of claim 1, further comprising:
receiving a notification that the client has completed the at least one first action; and
notifying the human advisor that the client has completed the at least one first action.

18. The method of claim 1, further comprising:
notifying the human advisor of the at least one first action that needs to be performed.

19. A system comprising one or more processors and a computer-readable medium storing computer program code configured, when executed by the one or more processors, to cause the one or more processors to perform a method of handling an incoming call from a client, comprising:
receiving call data comprising at least voice data generated based on the client's voice during the call;
processing the call data to identify, using at least one trained machine learning model, at least one first action that can be completed during the call by the client without assistance from a human advisor; and
inviting the client to complete the at least one first action.

20. The system of claim 19, wherein:
the call data further comprises client data specific to the client; and
processing the call data comprises:
inputting the voice data and the client data to the at least one trained machine learning model; and
identifying, based on an output of the at least one trained machine learning model, the at least one first action.
